(19) United States
(12) Patent Application Publication
(10) Pub. No.: US 2025/0069356 A1
(43) Pub. Date: Feb. 27, 2025

(54) OBJECT DETECTION AND VISUAL GROUNDING AT THE EDGE

(71) Applicant: SRI International, Menlo Park, CA (US)

(72) Inventors: Aswin NADAMUNI RAGHAVAN, Pennington, NJ (US); Jun HU, Princeton, NJ (US); David C. ZHANG, Belle Mead, NJ (US); Michael R. LOMNITZ, Castro Valley, CA (US); Yuzheng ZHANG, Princeton, NJ (US); Michael PIACENTINO, Southern Shores, NC (US); Philip MILLER, Yardley, PA (US); Zachary A. DANIELS, Robbinsville, NJ (US); Saurabh FARKYA, Jersey City, NJ (US); Abrar A. RAHMAN, Brooklyn, NY (US); Abdelrahman SHARAFELDIN, Atlanta, GA (US)

(21) Appl. No.: 18/815,217

(22) Filed: Aug. 26, 2024

Related U.S. Application Data
(60) Provisional application No. 63/534,743, filed on Aug. 25, 2023.

(51) Int. Cl. G06V 10/25; G06V 10/74

(52) U.S. Cl. CPC G06V 10/25; G06V 10/761; G06V 2201/07

(57) ABSTRACT

A method, apparatus, and system for object detection on an edge device include projecting a hyperdimensional vector of a query request for an image received at the edge device into a hyperdimensional embedding space to identify at least one exemplar in the hyperdimensional embedding space having a predetermined measure of similarity to the query request using a network trained to: generate a respective hyperdimensional image vector and a respective hyperdimensional text vector for the image and received text descriptions of the image, generate a hyperdimensional query text vector of the query request, combine and embed respective ones of the hyperdimensional image vectors and the hyperdimensional text vectors into a hyperdimensional embedding space to generate respective exemplars, project the hyperdimensional query text vector into the hyperdimensional embedding space, and determine a similarity measure between the hyperdimensional query text vector and at least one of the respective exemplars.

### CROSS-REFERENCE TO RELATED APPLICATIONS

This application claims benefit of and priority to U.S. Provisional Patent Application Ser. No. 63/534,743, filed Aug. 25, 2023.

### GOVERNMENT RIGHTS

This invention was made with Government support under 2022-21100600001 awarded by the Intelligence Advanced Research Projects Activity (IARPA). The Government has certain rights in the invention.

### FIELD OF THE INVENTION

Embodiments of the present principles generally relate to object detection and visual grounding in images and, more particularly, to a method, apparatus and system for few shot and zero shot object detection and visual grounding at the edge, for example on edge devices.

### BACKGROUND

Object detection and visual grounding involve identifying (e.g., labelling boxes) and localizing (e.g., providing a location for) objects in a given image in response to a user query. In various instances, a query can include a name of an object, a description of the object, a purpose of the object, and the like, in the form of text, images, or a combination of both.

Few-shot object detection and localization aims to perform object detection and localization with as few examples of, for example, labelled boxes as possible. Zero shot object detection and localization aims to detect and localize objects that have never been labelled before explicitly using commonalities shared between pre-trained object classes and an object query.

Current industry practice includes training object detectors on a large, annotated dataset. Such methods, however, do not work on object categories that are even slightly different than the training set. A small subset of object detectors are trained to be zero shot object detectors and few shot object detectors. Such methods, however, are less suitable for training and use at the edge, using a low fidelity edge processor.

### SUMMARY

Embodiments of the present principles provide a method, apparatus, and system for object detection and visual grounding, including few shot and zero shot object detection and visual grounding, at the edge, for example using edge devices.

In some embodiments, a method for training a hyperdimensional network for object detection and visual grounding on an edge device includes determining at least one region of interest for at least one of an image received at the edge device and at least one respective description of the image received at the edge device, generating, for each region of interest determined, a numerical image vector representation of a respective portion of the image and a numerical text vector representation of text of a respective portion of the descriptions of the image, generating a respective hyperdimensional image vector representation and a respective hyperdimensional text vector representation for each of the numerical image vector representations and the numerical text vector representations, combining respective ones of the hyperdimensional image vector representations and the hyperdimensional text vector representations, and embedding the respectively combined hyperdimensional image vector representations and hyperdimensional text vector representations into a common hyperdimensional embedding space, which preserves a high similarity of the respectively combined hyperdimensional image vector representations and hyperdimensional text vector representations, to generate respective exemplars which, when associated with a query representation projected into the common hyperdimensional embedding space, provide at least one of an identification and a visual grounding of at least one object portion.

In some embodiments, a method for object detection and visual grounding on an edge device includes receiving at the edge device a query request, projecting a hyperdimensional vector representation of at least one of an image of the received query request or a text of the received query request into a hyperdimensional embedding space to identify at least one of an object or a visual grounding of an object in a subject image using a network trained to determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments the method further includes using information associated with the identified exemplar, marking the subject image to indicate at least one of an object or a visual grounding of the object in the subject image in response to the query request.

In some embodiments, an apparatus for training a hyperdimensional network for object detection and visual grounding on an edge device includes a processor a memory accessible to the processor, the memory having stored therein at least one of programs or instructions executable by the processor to configure the apparatus to determine at least one region of interest for at least one of an image received at the edge device and at least one respective description of the image received at the edge device generate, for each region of interest determined, a numerical image vector representation of a respective portion of the image and a numerical text vector representation of text of a respective portion of the descriptions of the image, generate a respective hyperdimensional image vector representation and a respective hyperdimensional text vector representation for each of the numerical image vector representations and the numerical text vector representations, combine respective ones of the hyperdimensional image vector representations and the hyperdimensional text vector representations, and embed the respectively combined hyperdimensional image vector representations and hyperdimensional text vector representations into a common hyperdimensional embedding space, which preserves a high similarity of the respectively combined hyperdimensional image vector representations and hyperdimensional text vector representations, to generate respective exemplars which, when associated with a query representation projected into the common hyperdimensional embedding space, provide at least one of an identification and a visual grounding of at least one object portion.

In some embodiments, an apparatus for object detection and visual grounding on an edge device includes a processor and a memory accessible to the processor, the memory having stored therein at least one of programs or instructions executable by the processor to configure the apparatus to: project a hyperdimensional vector representation of at least one of an image of a received query request or a text of the received query request into a hyperdimensional embedding space to identify at least one of an object or a visual grounding of an object in a subject image using a network trained to: determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the apparatus is further configured to use information associated with the identified exemplar to mark the subject image to indicate at least one of an object or a visual grounding of the object in the subject image in response to the query request.

In some embodiments a system for object detection and visual grounding includes an edge device comprising a processor and a memory accessible to the processor, the memory having stored therein at least one of programs or instructions. In such embodiments when the programs or instructions are executed by the processor, the edge device is configured to: project a hyperdimensional vector representation of at least one of an image of a received query request or a text of the received query request into a hyperdimensional embedding space to identify at least one of an object or a visual grounding of an object in a subject image using a network of the edge device trained to; determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the edge device is further configured to use information associated with the identified exemplar, mark the subject image to indicate at least one of an object or a visual grounding of the object in the subject image in response to the query request.

In some embodiments, a non-transitory computer readable medium has stored thereon at least one program, the at least one program including instructions which, when executed by a processor, cause the processor to perform a method for object detection and visual grounding on an edge device including: projecting a hyperdimensional vector representation of at least one of an image of a received query request or a text of the received query request into a hyperdimensional embedding space to identify at least one of an object or a visual grounding of an object in a subject image using a network of the edge device trained to; determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the method further includes using information associated with the identified exemplar, mark the subject image to indicate at least one of an object or a visual grounding of the object in the subject image in response to the query request.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of an edge object detection and visual grounding system in accordance with at least one embodiment of the present principles.

FIG. 2 depicts a graph depicting a Mean Average Precision (mAP) for object detection of the edge object detection and visual grounding system in accordance with an embodiment of the present principles.

FIG. 3 depicts a Table showing the impact of vision+language on zero-shot mAP in accordance with embodiments of the present principles.

FIG. 4 depicts a Table showing the impact on visual grounding using exemplars of the present principles having respective purpose annotations/descriptions for images versus visual grounding using exemplars having only tool names in accordance with an embodiment of the present principles.

FIG. 5 depicts a Table of a comparison of the time to process an image using an edge object detection and visual grounding system of the present principles versus a high end datacenter level workstation/computer.

FIG. 6 depicts a flow diagram of a method for training a hyperdimensional network for edge object detection and visual grounding in accordance with an embodiment of the present principles.

FIG. 7 depicts a flow diagram of a method for object detection and visual grounding on an edge device in accordance with an embodiment of the present principles.

FIG. 8 depicts a high-level block diagram of a computing device suitable for use with an edge object detection and visual grounding system in accordance with at least one embodiment of the present principles.

FIG. 9 depicts a high-level block diagram of a network in which embodiments of an edge object detection and visual grounding system in accordance with the present principles can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for object detection and visual grounding at the edge (i.e., edge devices) including few shot and zero shot, and a method for training a network for few shot and zero shot object detection and visual grounding at the edge using edge devices. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described with respect to specific edge devices, embodiments of the present principles can be implemented with substantially any edge devices in accordance with the present principles.

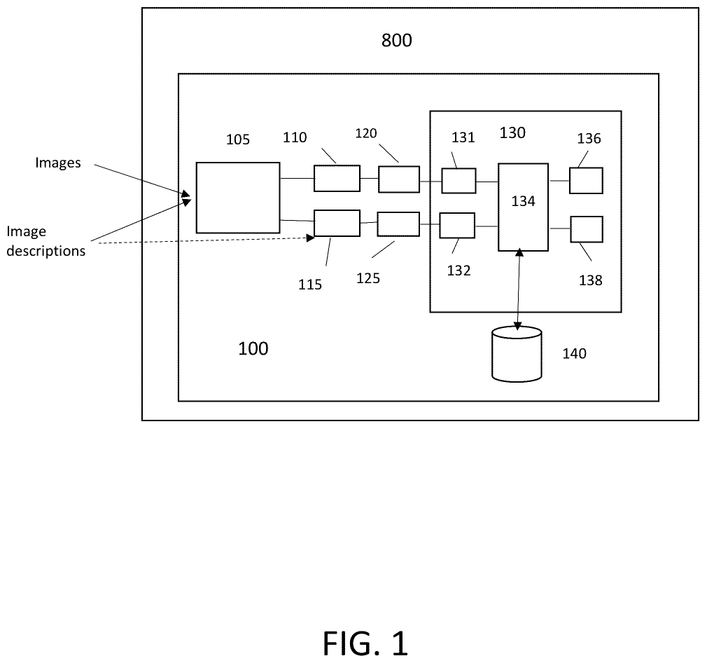

FIG. 1 depicts a high-level block diagram of an edge object detection and visual grounding system 100 in accordance with at least one embodiment of the present principles. The edge object detection and visual grounding system 100 of FIG. 1 illustratively comprises an optional region proposal module 105, a region of interest (ROI) crop module 110, a ROI caption module 115, a vision encoder 120 in communication with the ROI crop module 110, a language encoder 125 in communication with the ROI caption module 115, and a hyperdimensional (HD) network 130. In the embodiment of the edge object detection and visual grounding system 100 of FIG. 1, the HD network 130 comprises a first HD projection module 131 and a second HD projection module 132, a combine module 134, an exemplar embedding space 136 and a similarity/confidence module 138. As depicted in the edge object detection and visual grounding system 100 of FIG. 1, in some embodiments, an edge object detection and visual grounding system of the present principles can further include an optional hyperdimensional (HD) database 140 for implementing a Retrieval Augmented Generation (RAG) technique of the present principles (described in greater detail below).

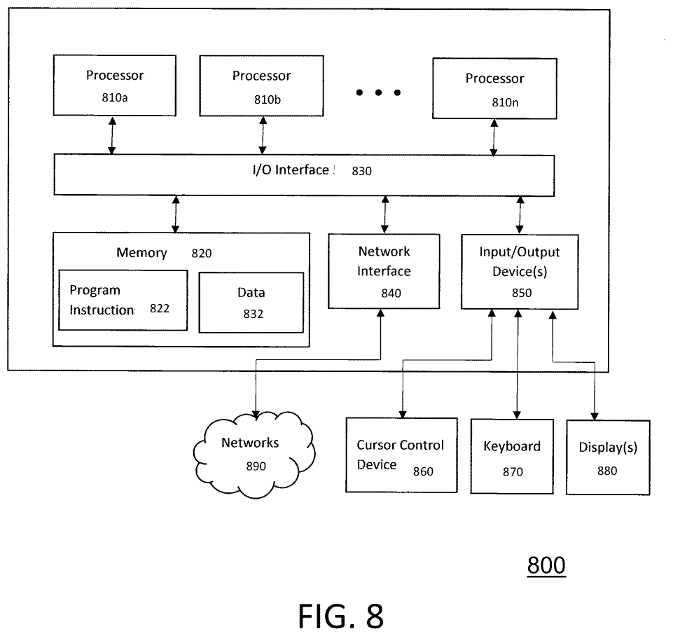

As depicted in FIG. 1, embodiments of an edge object detection and visual grounding system of the present principles, such as the edge object detection and visual grounding system 100 of FIG. 1, can be implemented via a computing device 800 (described in greater detail below with reference to FIG. 8) of, for example, an edge device in accordance with embodiments of the present principles. Such edge devices can include but are not limited to computing devices that operate at the edge of communications networks such as mobile phones, laptop computers, Internet of Things (IoT) devices, and the like.

During training, images (e.g., RGB images, depth images) can be received by the optional region proposal module 105 of the edge object detection and visual grounding system 100 of FIG. 1. More specifically, in the embodiment of the edge object detection and visual grounding system 100 of FIG. 1, during training the region proposal module 105 can receive images and can apply the concept of attention upon the images to guide subsequent modules to where to look for objects in received images. For example, in some embodiments, the region proposal module 105 can chop received images into patches.

Although not depicted in the embodiment of FIG. 1, in some embodiments the ROI crop module 110 can receive images to be processed either directly using, for example, an input output device of the computing device 800, or the images received by the region proposal module 105 can be forwarded to the ROI crop module 110 without processing.

In the embodiment of the edge object detection and visual grounding system 100 of FIG. 1, during training the weighted images from the region proposal module 105 can be communicated to the ROI crop module 110. The ROI crop module 110 can select a region of interest in the received images/portions of the images using, for example, the information received from the region proposal module 105. Alternatively or in addition and as described above, in some embodiments, the ROI crop module 110 of the edge object detection and visual grounding system 100 of FIG. 1 can determine regions of interest for images directly received. In some embodiments, to identify a region of interest, a ROI crop module 110 of the edge object detection and visual grounding system 100 of FIG. 1 can draw a bounding box around a determined object/portion of an object.

In the embodiment of the edge object detection and visual grounding system 100 of FIG. 1, the ROI caption module 115 can caption the determined regions of interest with a received, respective text description for the portion (e.g., object) of the image in each determined region of interest. That is, in some embodiments, an edge object detection and visual grounding system of the present principles, such as the edge object detection and visual grounding system 100 of FIG. 1, can receive descriptions and/or captions related to at least portions of the images for received images.

For example and as depicted in the embodiment of FIG. 1, the images received by the region proposal module 105 can include descriptions/captions for at least portions of the images (i.e., objects in the images). In some embodiments, the descriptions/captions of the images can include information (labels) describing at least portions (e.g., objects) of the images. For example, in some embodiments text descriptions and captions for objects, can include information for an image of a red fire truck including a text description for the object of “red fire truck”. In some embodiments of the present principles, a description of a portion (e.g., object) of an image can alternatively or in addition include the purpose/functionality of the object in the image, such as the image of a shovel having a purpose description of, “to dig a hole”.

Alternatively or in addition, in some embodiments data containing only an image is received by the region proposal module 105 and a related description/caption (e.g., description of objects and/or use of objects in the received image) can be provided via an input device such as a keyboard (e.g., a keyboard associated with the computing device 800) and/or a microphone by, for example, a user of the edge object detection and visual grounding system 100 of FIG. 1. In embodiments in which audio is implemented to input, for example, descriptions/captions of objects, at least one of the region proposal module 105 and/or the ROI caption module 115 can include an audio to text converter, such as a voice to text converter (not shown) to convert the audio description, and any other received audio (e.g., query requests) to text. In some embodiments, the ROI caption module 115 can associate respective text information of the image description with each ROI determined by the ROI crop module.

In the edge object detection and visual grounding system 100 of FIG. 1, during training the vision encoder module 120 creates respective numerical vectors for the portion (e.g., object) of the image in each region of interest (ROI). More specifically, in some embodiments, for each region of interest (ROI) segment determined by the ROI crop module 110, the vision encoder module 120 can further divide the image into smaller patches. For example, in some embodiments of the present principles, each region of interest determined by the ROI crop module 110 can be semantically segmented such that, in some embodiments, each pixel is assigned a semantic class. The vision encoder module 120 can then transform each smaller patch/segment into a respective numerical image vector. Alternatively, in some embodiments, the vision encoder module 120 can simply consider the image portions defined by the ROI crop module 110 for creating numerical vectors, and for the images/image portions in each region of interest, can determine a respective numerical vector. In some embodiments of the present principles, the vision encoder module 120 can use a foundation model like a Contrastive Language-Image Pre-training (CLIP) model to create numerical vectors as described herein. It should be noted that during inference, the vision encoder module 120 can perform similar functionality on an image of a received image query and transform the image of an image query into a numerical text vector. That is, in response to a received image query request, the language vision module 120 can also generate a numerical query image vector representation of an image of an image query request.

Similarly, in some embodiments, the language encoder module 125 can divide the text from the ROI caption module 115 into smaller segments to reflect the image segmented by the vision encoder module 120 and/or the region of interest determined by the ROI crop module 110. In some embodiments, the language encoder module 125 can further analyze the text in each of the segments to understand each word's meaning and how the words work together in that segment. The language encoder module 125 can then transform respective portions of the captions for each ROI or for the segmented sections, into a respective numerical vector. That is, in some embodiments, the vision encoder module 120 and the language encoder module 125 can respectively generate, for each region of interest determined by the ROI crop module 110 and/or the vision encoder module 120, a numerical image vector representation of a respective portion of the image and a numerical text vector representation of text of a respective portion of the descriptions of the image. It should be noted that during inference, the language encoder module 125 can perform similar functionality on text of a query and transform the text of a query into a numerical text vector. That is, in response to a received query request, the language encoder module 125 can also generate a numerical query text vector representation of text of the query request.

It should be noted that in some embodiments, a query for object detection and visual grounding can include both image and text data. In such embodiments, in an edge object detection and visual grounding system of the present principle, such as the edge object detection and visual grounding system 100 of FIG. 1, the language vision module 120 can generate a numerical query image vector representation of an image of the image portion of the query request and the language encoder module 125 can generate a numerical query text vector representation of a text portion of the query request in accordance with the present principles.

In the edge object detection and visual grounding system 100 of FIG. 1, the HD network 130 is implemented to adapt the working domain of the edge object detection and visual grounding system of the present principles to an online domain such that the object detection and visual grounding of the present principles can be performed on an edge device in accordance with the present principles. At least a portion of an embodiment of the HD network 130 of the present principles is described in commonly-owned U.S. patent application Ser. No. 18/282,049, filed on Mar. 24, 2022, which is herein incorporated by reference in its entirety.

In the embodiment of the edge object detection and visual grounding system 100 of FIG. 1, during training the first HD projection module 131 receives the numerical image vector information from the vision encoder module 120 and produces, for each ROI and/or segment, a hyperdimensional (HD) vector representation of the numerical image vector. Similarly, the second HD projection module 132 receives the vector information of the numerical text vector from the language encoder module 125 and produces, for each text segment associated with the ROI and/or segment, an HD vector representation of the numerical text vectors. For example, in some embodiments, the first 131 and the second 132 HD projection modules can perform non-MAC operations using, for example, look up table operations or SACC operations or neural network operations to convolve a data value with a weight to produce HD vector representations of the input data. In some embodiments, the SACC operation can implement a shift register and an accumulator (not shown), in which operation of the shift register is a function of the applied weight value. In some embodiments, a Generalized Ternary Connect (GTC) algorithm can be used such that weights are constrained to integer powers of two enabling floating point multiplication to be accomplished by the weights with bit shifts. It should be noted that during inference, the first 131 and the second 132 HD projection module can perform similar functionality on images and/or text of a query and can produce a respective HD vector representation of a numerical image vector and a numerical text vector previously determined for the image/text portions and the received query. That is, in response to a received query request, the first HD projection module 131 and the second HD projection module 132 can generate a hyperdimensional query image vector representation of the image of a query request and a hyperdimensional query text vector representation of the text of a query request from the numerical query image vector representation and the numerical query text vector representation generated by the vision encoder module 120 and the language encoder module 125.

In the embodiment of the edge object detection and visual grounding system 100 of FIG. 1, during training the HD vector representation of the image data and the HD vector representation of the text data are combined in the combine module 134 to produce exemplars, E. That is, in some embodiments, the HD vector representation of the image data and the HD vector representation of the text of the description data can be combined using an XOR binding to produce exemplars, E. More specifically, in some embodiments, the combine module 134 can combine respective ones of the hyperdimensional image vector representations and the hyperdimensional text vector representations to produce exemplars.

In accordance with the present principles, the combined HD vector representation of the image data and the HD vector representation of the text data can be embedded into the exemplar embedding space 136, which in at least some embodiments comprises a high-dimensional binary vector space preserving similarities, such as semantic similarities, between the HD image vectors and the HD text vectors. That is, in some embodiments, the combine module 134 can embed the respectively combined hyperdimensional image vector representations and hyperdimensional text vector representations into a common hyperdimensional embedding space, which preserves a high similarity (e.g., cosine similarity, hamming distance, etc.) of the respectively combined hyperdimensional image vector representations and hyperdimensional text vector representations, to generate respective exemplars.

It should be noted that, similarly, in response to a query request, the combine module 134 can project a hyperdimensional query text vector representation and/or a hyperdimensional image vector representation of the query request into the common hyperdimensional embedding space, such as the exemplar embedding space 136 of the edge object detection and visual grounding system 100 of FIG. 1, for identifying an exemplar in the HD embedding space having a specific similarity measure to the projected HD vector representation determined for the text and/or image of a query to detect an object and a region of interest in which the object is displayed in the image in accordance with the present principles.

That is and as described above, when a query request is received (i.e., during inference), the vision encoder module 120 can determine a respective numerical vector for any image portion of the query request. Similarly and as described above, the language encoder module 125 can determine a respective numerical text vector for any text portion of the query request. As further described above, in response to a received query request, the first HD projection module 131 and the second HD projection module 132 can generate a hyperdimensional query vector representation of at least one of the image of the query and the text of the query from the numerical query image vector representation and the numerical query text vector representation generated by the vision encoder module 120 and the language encoder module 125. The generated at least one HD query vector representation of at least one of the image of the query and the text of the query can then be projected by the combine module 134 into the exemplar embedding space 136.

Thereafter, in some embodiments of the present principles, a similarity measure between at least one the projected HD query vector representation of at least one of the image of the query and the text of the query and at least one of the respective exemplars can be determined by, for example the similarity/confidence module 138 to identify an exemplar having a highest degree of similarity measure to the projected hyperdimensional query text vector representation in the hyperdimensional embedding space to identify at least one object in the received image and a location of the at least one object in the received image. That is, the identified exemplar identifies an object and a region of interest (visual grounding) in which the object is displayed in the image.

That is, after training, when a query is received by an edge object detection and visual grounding system of the present principles, such as the edge object detection and visual grounding system 100 of FIG. 1, the query can be applied to each region of interest (ROI) determined for an image in question by an edge object detection and visual grounding system of the present principles. That is, in some embodiments, a query/inference is processed by an edge object detection and visual grounding system of the present principles, such as the edge object detection and visual grounding system 100 of FIG. 1, as an ROI and query pair and can be treated as a binary classification problem: given a user's query and a specific ROI, the probability that the ROI is not captioned by the query can be measured by a similarity measure, such as a hamming distance to determined exemplars, E. Alternatively or in addition, in some embodiments, a cosine similarity can be determined between the projected hyperdimensional query text vector in the hyperdimensional space and embedded exemplars in the hyperdimensional space to identify an exemplar to be used to identify an object and a location of the object in the image in response to the query request.

As described above, in some embodiments of the present principles, a similarity measure can be calculated by, for example, the similarity/confidence module 138 to determined at least a measure of similarity between an HD vector representation of the projected text and/or image of a query and an embedded exemplar. That is, in some embodiments, the similarity/confidence module 138 can determine a similarity measure, such as a cosine similarity, between at least one of a projected hyperdimensional query text and/or image vector representation determined for the text and/or image of a query and at least one embedded exemplar to determine an exemplar that is best representative of/can best respond to a query request. Alternatively or in addition, in some embodiments, the similarity/confidence module 138 can determine a hamming distance between a projected text and/or image of a query and at least one embedded exemplar to determine an exemplar that has a highest similarity measure to a query.

In accordance with the present principles, when a representative (i.e., best fit) exemplar is identified, an edge object detection and visual grounding system of the present principles, such as the edge object detection and visual grounding system 100 of FIG. 1 can cause an object identification and/or a visual grounding of at least a portion of an image and/or a location of the portion of the image to be marked in a subject image using the information contained in the identified exemplar(s). For example, in some embodiments of the present principles, when an exemplar with a highest degree of similarity is identified in response to a query request, the information contained in the identified exemplar can be used by a an edge object detection and visual grounding system of the present principles to mark a subject image with, for example, a bounding box, to identify at least one of a portion of an image (e.g., object in the image) or a location of the portion of the image in the subject image in response to a query request.

In embodiments in which a query request is received for an object for which the edge object detection and visual grounding system 100 of FIG. 1 has not been trained (e.g., zero shot/few shot), the similarity/confidence module 138 can determine a measure of similarity between an HD text and/or image vector representation (e.g., hyperdimensional query text vector and/or a hyperdimensional query image vector) of the zero shot query that has been projected into the exemplar embedding space 136 in accordance with the present principles and at least two or more exemplars embedded in the exemplar embedding space 136 in accordance with the present principles, to determine at least one exemplar in the exemplar embedding space 136 having a highest similarity/confidence score to the projected query. That is, in a zero shot query request embodiment, the text and/or image of the query request can be compared to at least one of the image(s) and the text descriptions of an image in exemplars in the HD embedding space to identify an exemplar most similar to/representative of the query request. Because in accordance with the present principles, images/image portions and respective text descriptions of images/image portions are used to train an edge object detection and visual grounding system of the present principles, such as the edge object detection and visual grounding system 100 of FIG. 1, the images/image portions and respective text descriptions when embedded into a high dimensional embedding space can be used to determine objects in images and locations of objects in the images for zero shot and few shot query request in embodiments in which an edge object detection and visual grounding system of the present principles has not been trained to identify the specific objects. In such instances, the embedded images/image portions and associated text descriptions can be used to at least identify similar objects and locations of the objects in images in response to zero shot and few shot query requests. For example, when a query request is made for a shovel, for which an edge object detection and visual grounding system of the present principles has not been trained, the edge object detection and grounding system of the present principles can embed the images and/or text of the request into an HD embedding space in accordance with the present principles and an exemplar of a spade can be determined for the query request because a spade, similar to a shovel, can also be used for digging.

In some embodiments, a description of the shovel “for digging” can be received with the query request for a shovel. Alternatively or in some embodiments, when a query request is received and converted to numerical vector(s) as described above using, for example, a foundation model like a Contrastive Language-Image Pre-training (CLIP) model, the conversion can capture similarities (i.e., “for digging”) between a shovel and a previously trained spade, and such similarities are retained through generation of HD vectors as described above.

Because an edge object detection and visual grounding system of the present principles had been trained using a spade along with the description “for digging”, an edge object detection and visual grounding system of the present principles can identify a spade in response to the query request. More specifically, in the above described zero shot query request for a shovel, the description of the shovel is embedded in the HD embedding space in accordance with the present principles and as described, and similarity measures are determined between the description of the shovel and embedded exemplars having object/image descriptions and an exemplar including a spade was rated as having the highest similarity measure to the shovel description and, as such, the exemplar of the spade is selected in response to the query request. As such, and in accordance with the present principles an object and ROI (visual grounding) of the object associated with a determined best exemplar and having a highest similarity/confidence score, can be selected in response to the query request.

In accordance with the present principles, additional exemplars can be created (i.e., on the fly) by an edge object detection and visual grounding system of the present principles, such as the edge object detection and visual grounding system 100 of FIG. 1, for new instances of received data. For example, during instances in which a query request is received for data for which an edge object detection and visual grounding system of the present principles has not been trained (i.e., zero shot), when an exemplar with highest similarity is identified in accordance with the present principles and as described above, the information in the identified exemplar can be combined with the data in the query request to create an additional exemplar. For example, in the example above in which a query included a request for the identification of a shovel and an identified, highest similarity exemplar included the information of a spade that can be used for digging, a new exemplar can be made by an edge object detection and visual grounding system of the present principles, such as the edge object detection and visual grounding system 100 of FIG. 1, to include at least an image of a shovel and a description that a shovel can be used for digging. Vector representations of such information can then be embedded into, for example, the exemplar embedding space 136 as a new exemplar.

In some embodiments of the present principles, a confidence score/threshold can be selected above which or, alternatively, below which exemplars having such a confidence score can be selected in response to the query. That is, in some embodiments of the present principles, identified exemplars below a confidence score/threshold can be filtered out. In some embodiments, the threshold of the present principles can vary with system performance, edge precision vs speed/battery usage, and/or human feedback.

In one experimental embodiment, an edge object detection and visual grounding system of the present principles, such as the edge object detection and visual grounding system 100 of FIG. 1, was implemented for identifying tools in a workshop. In the experimental embodiment, visual input came from a webcam mounted on a tripod that could be moved around a tool display area. A headset with a microphone was used for audio input to the system and specifically for providing descriptions for the input images. Automatic speech-to-text using a wav2vec2 architecture was used to convert audio to text.

In the experimental embodiment, during training of the edge object detection and visual grounding system, images of objects (e.g., a shovel) were input with respective text (from audio) describing at least a name of an object (shovel) and, in some instances, a purpose (e.g., to dig a hole) of the object to help enable the system to identify new tools (i.e., zero shot) with similar purpose (e.g., a spade can also dig a hole).

In the experimental embodiment, two datasets were used for evaluating domain adaptation of an edge object detection and visual grounding system of the present principles. The first dataset implemented was the ALET dataset, which consists of 50 tools with multiple tools per image in cluttered environments. The second dataset implemented was the SKIML dataset, which is a proprietary dataset with 12 tools with one tool per image. SKIML and ALET classes have some common tools but not all tools are in common. The edge object detection and visual grounding system of the present principles was trained on the SKIML dataset and tested on the ALET dataset, and vice-versa, to evaluate zero-shot performance. In the experimental embodiment, during training two exemplars were created per tool using names/descriptions of each tool and purpose descriptions of each tool.

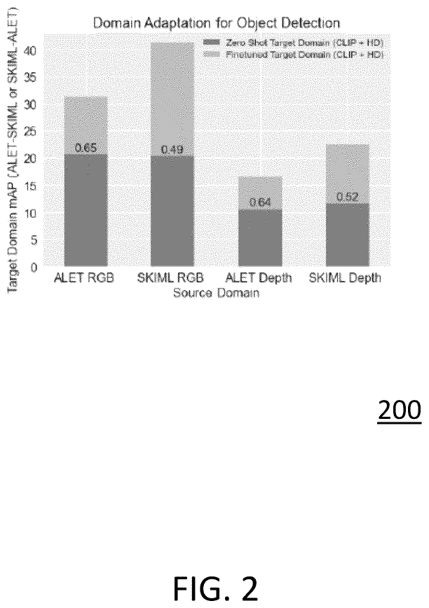

FIG. 2 depicts a graph 200 depicting a Mean Average Precision (mAP) for object detection of the edge object detection and visual grounding system of the experimental embodiment. That is, FIG. 2 depicts a Mean Average Precision (mAP) for zero-shot (dark gray) and finetuned (light gray) object detection after training on source domain (x-axis) and tested on target domain (y-axis). As depicted in FIG. 2, the edge object detection and visual grounding system of the present principles achieves non-trivial zero-shot mAP that is about 50% of the finetuned mAP on the target domain and is able to transfer from 12 SKIML tools to 50 ALET tools (20 mAP zero-shot vs 40 mAP finetuning). The high zero-shot precision of an edge object detection and visual grounding system of the present principles is due to the combination of vision and language modalities in accordance with the present principles.

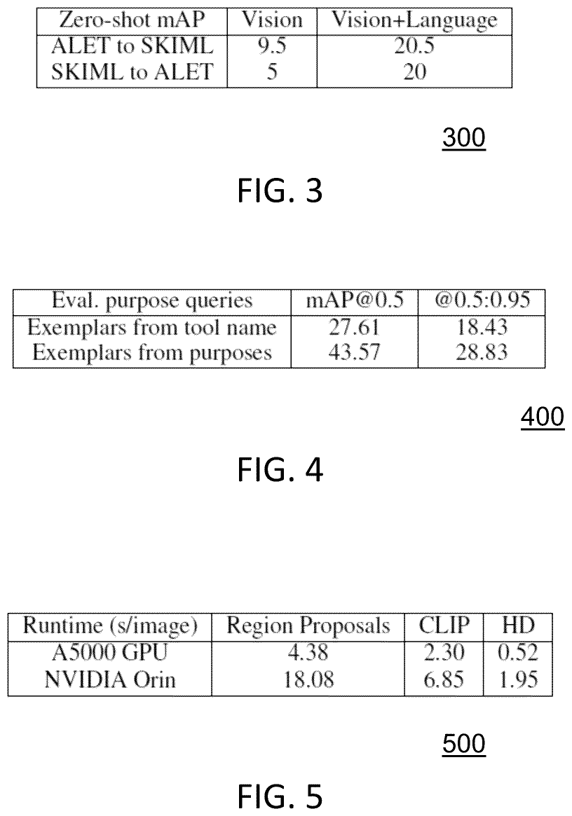

FIG. 3 depicts a Table 300 showing the impact of vision+language on zero-shot mAP in accordance with the present principles. That is, FIG. 3 depicts a Table 300 showing the results for zero-shot mAP when using vision only and when using vision+language for the experimental embodiment of the edge object detection and visual grounding system of the present principles for both the ALET to SKIML scenario and the SKIML to ALET scenario. As depicted in the Table 300 of FIG. 3, the results for zero-shot mAP are greatly increased when an edge object detection and visual grounding system of the present principles is trained with both vision+language for both scenarios.

FIG. 4 depicts a Table showing the impact on visual grounding using exemplars of the present principles having respective purpose annotations/descriptions for images versus visual grounding using exemplars having only tool names in accordance with an embodiment of the present principles. That is, FIG. 4 depicts a Table 400 showing the impact of generating exemplars of the present principles using respective purpose annotations/descriptions for images versus generating exemplars using only tool names in accordance with an embodiment of the present principles. As depicted in the Table 400 of FIG. 4, the mAP for an edge object detection and visual grounding system of the present principles is greatly increased when exemplars are generated using respective purpose annotations/descriptions for images versus generating exemplars using only tool names.

The experimental embodiment of the edge object detection and visual grounding system of the present principles was tested on the edge device, NVIDIA® Orin, and validated against a GPU server (NVIDIA® A5000). FIG. 5 depicts a Table 500 of a comparison of the time to process an image using an edge object detection and visual grounding system of the present principles versus a high end datacenter level workstation/computer. As depicted in the Table 500 of FIG. 5, the process time is dominated by generating region proposals. However, region proposals have to be generated only once to process all queries. When a new query is entered, only the HD text embedding (illustratively Contrastive Language-Image Pre-training (CLIP) embeddings) and the similarity measures (e.g., hamming distances and/or cosine similarities) to exemplars have to be recomputed and, as depicted in the Table 500 of FIG. 5, the binary HD operations are fast. The Table 500 of FIG. 5 depicts that the processing times of an edge object detection and visual grounding system of the present principles, such as the edge object detection and visual grounding system 100 of FIG. 1, are comparable to processing times for an object detection system executed on a computer.

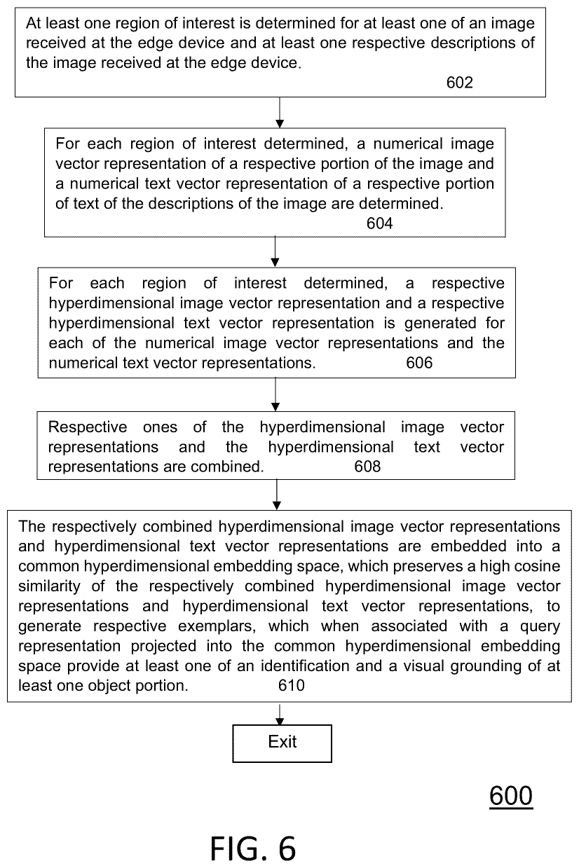

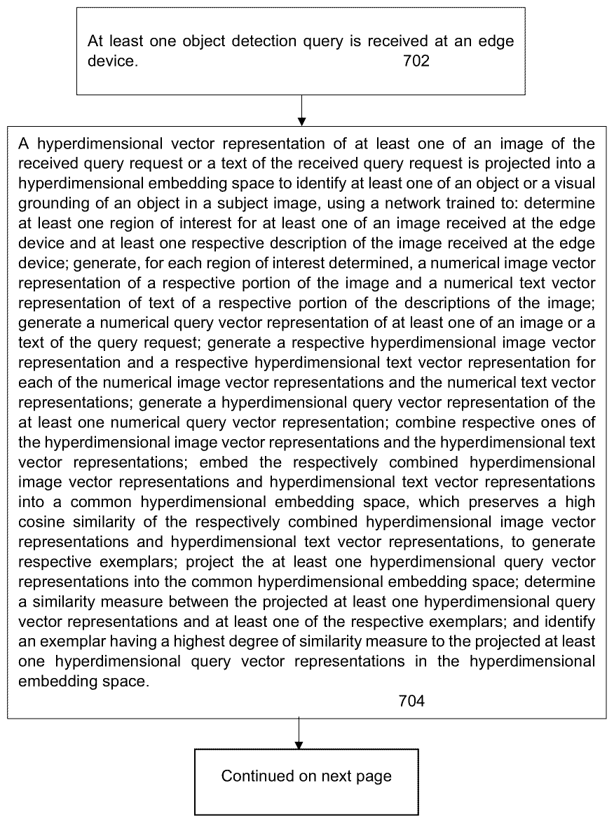

FIG. 6 depicts a flow diagram of a method 600 for training a hyperdimensional network for object detection and visual grounding on an edge device in accordance with an embodiment of the present principles. The method 600 can begin at 602 during which at least one region of interest is determined for at least one of an image received at the edge device and at least one respective descriptions of the image received at the edge device. The method 600 can proceed to 604.

At 604, for each region of interest determined, a numerical image vector representation of a respective portion of the image and a numerical text vector representation of a respective portion of text of the descriptions of the image are determined. The method 600 can proceed to 606.

At 606, for each region of interest determined, a respective hyperdimensional image vector representation and a respective hyperdimensional text vector representation is generated for each of the numerical image vector representations and the numerical text vector representations. The method 600 can proceed to 608.

At 608, respective ones of the hyperdimensional image vector representations and the hyperdimensional text vector representations are combined. The method 600 can proceed to 610.

At 610, the respectively combined hyperdimensional image vector representations and hyperdimensional text vector representations are embedded into a common hyperdimensional embedding space, which preserves a high cosine similarity of the respectively combined hyperdimensional image vector representations and hyperdimensional text vector representations, to generate respective exemplars, which when associated with a query representation projected into the common hyperdimensional embedding space provide at least one of an identification and a visual grounding of at least one object portion. The method 600 can then be exited.

In some embodiments, the method 600 can further include generating a numerical query vector representation of at least one of a text portion or an image portion of a query received at the edge device, generating a hyperdimensional query vector representation for each numerical query vector representation, projecting the hyperdimensional query vector representations into the common hyperdimensional embedding space, and determining a similarity measure between the projected hyperdimensional query vector representations and at least one of the respective exemplars.

In some embodiments, the method can further include generating a numerical query vector representation of at least one of a text portion or an image portion of a query received at the edge device, generating a hyperdimensional query vector representation for each numerical query vector representation, projecting the hyperdimensional query vector representations into the common hyperdimensional embedding space, and determining a similarity measure between the projected hyperdimensional query vector representations and at least one of the respective exemplars.

In some embodiments, the method can further include receiving the descriptions of the image received at the edge device as audio, and converting the received audio descriptions of the image received at the edge device to text.

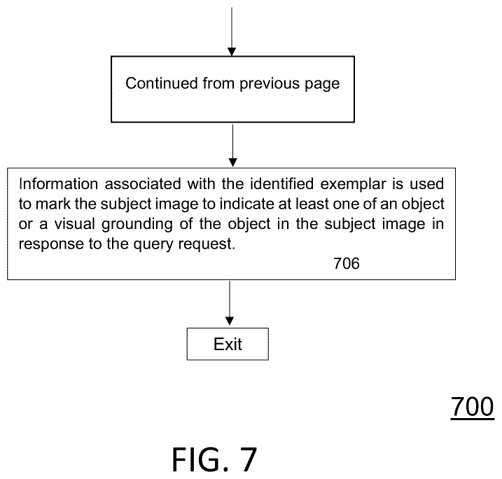

FIG. 7 depicts a flow diagram of a method 700 for object detection and visual grounding on an edge device in accordance with an embodiment of the present principles. The method 700 can begin at 702 during which an object detection query is received at the edge device. The method 700 can proceed to 704.

At 704, a hyperdimensional vector representation of at least one of an image of the received query request or a text of the received query request is projected into a hyperdimensional embedding space to identify at least one of an object or a visual grounding of an object in a subject image, using a network trained to: determine at least one region of interest for at least one of an image received at the edge device and at least one respective description of the image received at the edge device; generate, for each region of interest determined, a numerical image vector representation of a respective portion of the image and a numerical text vector representation of text of a respective portion of the descriptions of the image; generate a numerical query vector representation of at least one of an image or a text of the query request; generate a respective hyperdimensional image vector representation and a respective hyperdimensional text vector representation for each of the numerical image vector representations and the numerical text vector representations; generate a hyperdimensional query vector representation of the at least one numerical query vector representation; combine respective ones of the hyperdimensional image vector representations and the hyperdimensional text vector representations; embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars; project the at least one hyperdimensional query vector representations into the common hyperdimensional embedding space; determine a similarity measure between the projected at least one hyperdimensional query vector representations and at least one of the respective exemplars; and identify an exemplar having a highest degree of similarity measure to the projected at least one hyperdimensional query vector representations in the hyperdimensional embedding space. The method 700 can proceed to 706.

At 706, information associated with the identified exemplar is used to mark the subject image to indicate at least one of an object or a visual grounding of the object in the subject image in response to the query request. The method 700 can be exited.

In some embodiments, the method can further include converting descriptions of the image received at the edge device to text and/or converting the query request to text.

In some embodiments, the method can further include identifying an exemplar having a highest degree of similarity measure to the projected hyperdimensional query text vector representation in the hyperdimensional embedding space to identify at least one object in the received image and a location of the at least one object in the received image in response to the received query request.

In some embodiments, the method can further include determining a similarity measure threshold for determining which exemplars in the hyperdimensional embedding space to identify in response to the received query request.

In some embodiments, the marking includes generating a bounding box.

In some embodiments, the method further includes using the at least one hyperdimensional query vector representations to search a high-dimensional vector database for data related to the query search, and using related data of the high-dimensional vector database identified as a result of the search to at least one of generate additional exemplars or assist to identify the exemplar having a highest degree of similarity measure to the projected at least one hyperdimensional query vector representations in the hyperdimensional embedding space.

In some embodiments, information representative of the related data of the high-dimensional vector database identified as a result of the search is projected into the common hyperdimensional embedding space to assist to identify the exemplar having a highest degree of similarity measure.

In some embodiments, the method can further include determining a similarity measure threshold for determining which exemplars in the hyperdimensional embedding space to identify in response to the received query request.

In some embodiments of the present principles, the optional hyperdimensional (HD) database 140 of FIG. 1 can be used for implementing a Retrieval Augmented Generation (RAG) technique in an edge object detection and visual grounding system of the present principles, such as the edge object detection and visual grounding system 100 of FIG. 1. More specifically, in some embodiments, after training of the edge object detection and visual grounding system 100 of FIG. 1, as described above, when a query is an HD query vector representation is generated for at least one of the image of the query and the text of the query. In some embodiments, the HD query vector representation(s) can be communicated by, for example, the combine module 134 to the HD database 140. In some embodiments, in response to the received query, a search engine (not shown) of the HD database 140 searches for examples (e.g., datapoints) in the HD database 140 relevant to the received query.

That is, in the embodiment of the edge object detection and visual grounding system 100 of FIG. 1, the HD database 140 can comprise a hyperdimensional vector database containing datapoints (data examples) intended to supplement the data (e.g., image and text data) used to train the edge object detection and visual grounding system 100 of FIG. 1. In some embodiments, such HD database of the present principles, such as the HD database 140 of FIG. 1, can be provided by a user of the edge object detection and visual grounding system 100 of FIG. 1 to supplement the data used to train the edge object detection and visual grounding system 100.

The search results (e.g., relevant data) of the search engine (not shown) of the HD database 140 can be provided to, for example, the combine module 134 of the edge object detection and visual grounding system 100 of FIG. 1 and, in some embodiments, can be projected into the exemplar embedding space 136 along with the HD representations of at least one of the image and text of the query by, for example, the combine module 134 to attempt to identify at least one an exemplar most similar to/representative of the query request as previously described above.

In accordance with the present principles, in some embodiments, any additional data determined from the HD database 140 can be implemented by an edge object detection and visual grounding system of the present principles to create additional exemplars (e.g., on the fly). For example, during instances in which the additional data received from the HD database 140 along with a query request has not been previously seen (i.e., used to train) by an edge object detection and visual grounding system of the present principles, such as the edge object detection and visual grounding system 100 of FIG. 1, the additional data from the HD database 140 can be used (i.e., in some instance along with the data in the query request) to create an additional exemplar in accordance with the present principles. Vector representations of such information can then be embedded into, for example, the exemplar embedding space 136 as a new exemplar.

Although in the embodiment of the edge object detection and visual grounding system 100 of FIG. 1 the HD database 140 is illustrated as a single HD database located in/integrated into the computing device 800 which can be a computing device of an edge device, alternatively or in addition, the HD database of the present principles can include one or more databases, and/or in some embodiments can comprise a distributed database, that can be located anywhere that an edge object detection and visual grounding system of the present principles, such as the edge object detection and visual grounding system 100 of FIG. 1, can access.

In some embodiments, an apparatus for training a hyperdimensional network for object detection and visual grounding on an edge device includes a processor a memory accessible to the processor, the memory having stored therein at least one of programs or instructions executable by the processor to configure the apparatus to determine at least one region of interest for at least one of an image received at the edge device and at least one respective description of the image received at the edge device generate, for each region of interest determined, a numerical image vector representation of a respective portion of the image and a numerical text vector representation of text of a respective portion of the descriptions of the image, generate a respective hyperdimensional image vector representation and a respective hyperdimensional text vector representation for each of the numerical image vector representations and the numerical text vector representations, combine respective ones of the hyperdimensional image vector representations and the hyperdimensional text vector representations, and embed the respectively combined hyperdimensional image vector representations and hyperdimensional text vector representations into a common hyperdimensional embedding space, which preserves a high similarity of the respectively combined hyperdimensional image vector representations and hyperdimensional text vector representations, to generate respective exemplars which, when associated with a query representation projected into the common hyperdimensional embedding space, provide at least one of an identification and a visual grounding of at least one object portion.

In some embodiments, an apparatus for object detection and visual grounding on an edge device includes a processor and a memory accessible to the processor, the memory having stored therein at least one of programs or instructions executable by the processor to configure the apparatus to: project a hyperdimensional vector representation of at least one of an image of a received query request or a text of the received query request into a hyperdimensional embedding space to identify at least one of an object or a visual grounding of an object in a subject image using a network trained to: determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the apparatus is further configured to use information associated with the identified exemplar to mark the subject image to indicate at least one of an object or a visual grounding of the object in the subject image in response to the query request.

In some embodiments a system for object detection and visual grounding includes an edge device comprising a processor and a memory accessible to the processor, the memory having stored therein at least one of programs or instructions. In such embodiments when the programs or instructions are executed by the processor, the edge device is configured to: project a hyperdimensional vector representation of at least one of an image of a received query request or a text of the received query request into a hyperdimensional embedding space to identify at least one of an object or a visual grounding of an object in a subject image using a network of the edge device trained to; determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the edge device is further configured to use information associated with the identified exemplar, mark the subject image to indicate at least one of an object or a visual grounding of the object in the subject image in response to the query request.

In some embodiments, a non-transitory computer readable medium has stored thereon at least one program, the at least one program including instructions which, when executed by a processor, cause the processor to perform a method for object detection and visual grounding on an edge device including: projecting a hyperdimensional vector representation of at least one of an image of a received query request or a text of the received query request into a hyperdimensional embedding space to identify at least one of an object or a visual grounding of an object in a subject image using a network of the edge device trained to; determine at least one region of interest for at least one of an image received at the edge device and at least one respective description of the image received at the edge device, generate, for each region of interest determined, a numerical image vector representation of a respective portion of the image and a numerical text vector representation of text of a respective portion of the descriptions of the image, generate a numerical query vector representation of at least one of an image or a text of the query request, generate a respective hyperdimensional image vector representation and a respective hyperdimensional text vector representation for each of the numerical image vector representations and the numerical text vector representations, generate a hyperdimensional query vector representation of the at least one numerical query vector representation, combine respective ones of the hyperdimensional image vector representations and the hyperdimensional text vector representations, embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars, project the at least one hyperdimensional query vector representations into the common hyperdimensional embedding space, determine a similarity measure between the projected at least one hyperdimensional query vector representations and at least one of the respective exemplars, and identify an exemplar having a highest degree of similarity measure to the projected at least one hyperdimensional query vector representations in the hyperdimensional embedding space. In some embodiments, the method further includes using information associated with the identified exemplar, mark the subject image to indicate at least one of an object or a visual grounding of the object in the subject image in response to the query request.

As depicted in FIG. 1, embodiments of an edge object detection and visual grounding system of the present principles, such as the edge object detection and visual grounding system 100 of FIG. 1, can be implemented in a computing device 800 in accordance with the present principles. That is, in some embodiments, image and text data can be communicated to, for example, the region proposal module 105 of the edge object detection and visual grounding system 100 of FIG. 1 using the computing device 800 via, for example, any input/output means associated with the computing device 800. Data associated with an edge object detection and visual grounding system in accordance with the present principles can be presented to a user using an output device of the computing device 800, such as a display, a printer or any other form of output device.

For example, FIG. 8 depicts a high-level block diagram of a computing device 800 of an edge device suitable for use with embodiments of an edge object detection and visual grounding system in accordance with the present principles, such as the edge object detection and visual grounding system 100 of FIG. 1. In some embodiments, the computing device 800 can be configured to implement methods of the present principles as processor-executable program instructions 822 (e.g., program instructions executable by processor(s) 810) in various embodiments.

In the embodiment of FIG. 8, the computing device 800 includes one or more processors 810a-810n coupled to a system memory 820 via an input/output (I/O) interface 830. The computing device 800 further includes a network interface 840 coupled to I/O interface 830, and one or more input/output devices 850, such as cursor control device 860, keyboard 870, and display(s) 880. In various embodiments, a user interface can be generated and displayed on display 880. In some cases, it is contemplated that embodiments can be implemented using a single instance of computing device 800, while in other embodiments multiple such systems, or multiple nodes making up the computing device 800, can be configured to host different portions or instances of various embodiments. For example, in one embodiment some elements can be implemented via one or more nodes of the computing device 800 that are distinct from those nodes implementing other elements. In another example, multiple nodes may implement the computing device 800 in a distributed manner.

In different embodiments, the computing device 800 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 800 can be a uniprocessor system including one processor 810, or a multiprocessor system including several processors 810 (e.g., two, four, eight, or another suitable number). Processors 810 can be any suitable processor capable of executing instructions. For example, in various embodiments processors 810 may be general-purpose or embedded processors implementing any of a variety of instruction set architectures (ISAs). In multiprocessor systems, each of processors 810 may commonly, but not necessarily, implement the same ISA.

System memory 820 can be configured to store program instructions 822 and/or data 832 accessible by processor 810. In various embodiments, system memory 820 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 820. In other embodiments, program instructions and/or data can be received, sent or stored upon different types of computer-accessible media or on similar media separate from system memory 820 or computing device 800.

In one embodiment, I/O interface 830 can be configured to coordinate I/O traffic between processor 810, system memory 820, and any peripheral devices in the device, including network interface 840 or other peripheral interfaces, such as input/output devices 850. In some embodiments, I/O interface 830 can perform any necessary protocol, timing or other data transformations to convert data signals from one component (e.g., system memory 820) into a format suitable for use by another component (e.g., processor 810). In some embodiments, I/O interface 830 can include support for devices attached through various types of peripheral buses, such as a variant of the Peripheral Component Interconnect (PCI) bus standard or the Universal Serial Bus (USB) standard, for example. In some embodiments, the function of I/O interface 830 can be split into two or more separate components, such as a north bridge and a south bridge, for example. Also, in some embodiments some or all of the functionality of I/O interface 830, such as an interface to system memory 820, can be incorporated directly into processor 810.

Network interface 840 can be configured to allow data to be exchanged between the computing device 800 and other devices attached to a network (e.g., network 890), such as one or more external systems or between nodes of the computing device 800. In various embodiments, network 890 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 850 can, in some embodiments, include one or more display terminals, keyboards, keypads, touchpads, scanning devices, voice or optical recognition devices, or any other devices suitable for entering or accessing data by one or more computer systems. Multiple input/output devices 850 can be present in computer system or can be distributed on various nodes of the computing device 800. In some embodiments, similar input/output devices can be separate from the computing device 800 and can interact with one or more nodes of the computing device 800 through a wired or wireless connection, such as over network interface 840.

Those skilled in the art will appreciate that the computing device 800 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 800 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 800 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 800 can further include a web browser.

Although the computing device 800 is depicted as a general-purpose computer, the computing device 800 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

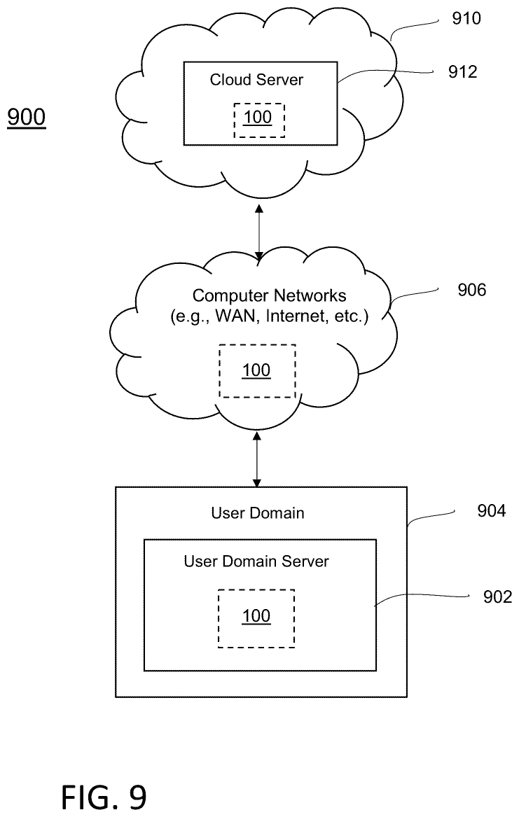

FIG. 9 depicts a high-level block diagram of a network in which embodiments of an edge object detection and visual grounding system in accordance with the present principles, such as the edge object detection and visual grounding system 100 of FIG. 1, can be applied. The network environment 900 of FIG. 9 illustratively comprises a user domain 902 including a user domain server/computing device 904. The network environment 900 of FIG. 9 further comprises computer networks 906, and a cloud environment 910 including a cloud server/computing device 912.

In the network environment 900 of FIG. 9, a system for object detection on an edge device in accordance with the present principles, such as edge object detection and visual grounding system 100 of FIG. 1, can be included in at least one of the user domain server/computing device 904, the computer networks 906, and the cloud server/computing device 912. That is, in some embodiments, a user can use a local server/computing device (e.g., the user domain server/computing device 904) to provide image data and associated image descriptions in accordance with the present principles.

In some embodiments, a user can implement a system for object detection on an edge device in the computer networks 906 to provide image data and associated image descriptions in accordance with the present principles. Alternatively or in addition, in some embodiments, a user can implement a system for object detection on an edge device in the cloud server/computing device 912 of the cloud environment 910 in accordance with the present principles. For example, in some embodiments it can be advantageous to perform processing functions of the present principles in the cloud environment 910 to take advantage of the processing capabilities and storage capabilities of the cloud environment 910. In some embodiments in accordance with the present principles, a system for object detection on an edge device of the present principles can be located in a single and/or multiple locations/servers/computers to perform all or portions of the herein described functionalities of a system in accordance with the present principles. For example, in some embodiments components of an edge object detection and visual grounding system of the present principles, such as the region proposal module 105 of the edge object detection and visual grounding system 100 of FIG. 1, can be located in one or more than one of the user domain 902, the computer network environment 906, and the cloud environment 910 for providing the functions described above either locally and/or remotely and/or in a distributed manner.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 800 can be transmitted to the computing device 800 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

The invention claimed is:

1. A method for training a hyperdimensional network for object detection and visual grounding on an edge device, comprising:
determining at least one region of interest for at least one of an image received at the edge device and at least one respective description of the image received at the edge device;
generating, for each region of interest determined, a numerical image vector representation of a respective portion of the image and a numerical text vector representation of text of a respective portion of the descriptions of the image;
generating a respective hyperdimensional image vector representation and a respective hyperdimensional text vector representation for each of the numerical image vector representations and the numerical text vector representations;
combining respective ones of the hyperdimensional image vector representations and the hyperdimensional text vector representations; and
embedding the respectively combined hyperdimensional image vector representations and hyperdimensional text vector representations into a common hyperdimensional embedding space, which preserves a high similarity of the respectively combined hyperdimensional image vector representations and hyperdimensional text vector representations, to generate respective exemplars, which when associated with a query representation projected into the common hyperdimensional embedding space provide at least one of an identification and a visual grounding of at least one object portion.

2. The method of claim 1, further comprising:
generating a numerical query vector representation of at least one of a text portion or an image portion of a query received at the edge device;
generating a hyperdimensional query vector representation for each numerical query vector representation;
projecting the hyperdimensional query vector representations into the common hyperdimensional embedding space; and
determining a similarity measure between the projected hyperdimensional query vector representations and at least one of the respective exemplars.

3. The method of claim 1, further comprising:
receiving the descriptions of the image received at the edge device as audio; and
converting the received audio descriptions of the image received at the edge device to text.

4. A method for object detection and visual grounding on an edge device, comprising:
receiving at the edge device a query request;
projecting a hyperdimensional vector representation of at least one of an image of the received query request or a text of the received query request into a hyperdimensional embedding space to identify at least one of an object or a visual grounding of an object in a subject image using a network trained to:
determine at least one region of interest for at least one of an image received at the edge device and at least one respective description of the image received at the edge device;
generate, for each region of interest determined, a numerical image vector representation of a respective portion of the image and a numerical text vector representation of text of a respective portion of the descriptions of the image;
generate a numerical query vector representation of at least one of an image or a text of the query request;
generate a respective hyperdimensional image vector representation and a respective hyperdimensional text vector representation for each of the numerical image vector representations and the numerical text vector representations;
generate a hyperdimensional query vector representation of the at least one numerical query vector representation;
combine respective ones of the hyperdimensional image vector representations and the hyperdimensional text vector representations;
embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars;
project the at least one hyperdimensional query vector representations into the common hyperdimensional embedding space;
determine a similarity measure between the projected at least one hyperdimensional query vector representations and at least one of the respective exemplars; and
identify an exemplar having a highest degree of similarity measure to the projected at least one hyperdimensional query vector representations in the hyperdimensional embedding space; and
using information associated with the identified exemplar, marking the subject image to indicate at least one of an object or a visual grounding of the object in the subject image in response to the query request.

5. The method of claim 4, wherein the marking comprises generating a bounding box.

6. The method of claim 4, further comprising:
at least one of:
converting descriptions of the image received at the edge device to text; or
converting the query request to text.

7. The method of claim 4, further comprising:
using the at least one hyperdimensional query vector representations to search a high-dimensional vector database for data related to the query search; and
using related data of the high-dimensional vector database identified as a result of the search to at least one of create additional exemplars or assist to identify the exemplar having a highest degree of similarity measure to the projected at least one hyperdimensional query vector representations in the hyperdimensional embedding space.

8. The method of claim 7, wherein information representative of the related data of the high-dimensional vector database identified as a result of the search is projected into the common hyperdimensional embedding space to assist to identify the exemplar having a highest degree of similarity measure.

9. The method of claim 7, wherein the method further comprises:
determining a similarity measure threshold for determining which exemplars in the hyperdimensional embedding space to identify in response to the received query request.

10. An apparatus for training a hyperdimensional network for object detection and visual grounding on an edge device, comprising:
a processor; and
a memory accessible to the processor, the memory having stored therein at least one of programs or instructions executable by the processor to configure the apparatus to:
determine at least one region of interest for at least one of an image received at the edge device and at least one respective description of the image received at the edge device;
generate, for each region of interest determined, a numerical image vector representation of a respective portion of the image and a numerical text vector representation of text of a respective portion of the descriptions of the image;
generate a respective hyperdimensional image vector representation and a respective hyperdimensional text vector representation for each of the numerical image vector representations and the numerical text vector representations;
combine respective ones of the hyperdimensional image vector representations and the hyperdimensional text vector representations; and
embed the respectively combined hyperdimensional image vector representations and hyperdimensional text vector representations into a common hyperdimensional embedding space, which preserves a high similarity of the respectively combined hyperdimensional image vector representations and hyperdimensional text vector representations, to generate respective exemplars which, when associated with a query representation projected into the common hyperdimensional embedding space, provide at least one of an identification and a visual grounding of at least one object portion.

11. The apparatus of claim 10, wherein the apparatus is further configured to:
generate a numerical query vector representation of at least one of a text portion or an image portion of a query received at the edge device;
generate a hyperdimensional query vector representation for each numerical query vector representation;
project the hyperdimensional query vector representations into the common hyperdimensional embedding space; and
determine a similarity measure between the projected hyperdimensional query vector representations and at least one of the respective exemplars.

12. An apparatus for object detection and visual grounding on an edge device, comprising:
a processor; and
a memory accessible to the processor, the memory having stored therein at least one of programs or instructions executable by the processor to configure the apparatus to:
project a hyperdimensional vector representation of at least one of an image of a received query request or a text of the received query request into a hyperdimensional embedding space to identify at least one of an object or a visual grounding of an object in a subject image using a network trained to:
determine at least one region of interest for at least one of an image received at the edge device and at least one respective description of the image received at the edge device;
generate, for each region of interest determined, a numerical image vector representation of a respective portion of the image and a numerical text vector representation of text of a respective portion of the descriptions of the image;
generate a numerical query vector representation of at least one of an image or a text of the query request;
generate a respective hyperdimensional image vector representation and a respective hyperdimensional text vector representation for each of the numerical image vector representations and the numerical text vector representations;
generate a hyperdimensional query vector representation of the at least one numerical query vector representation;
combine respective ones of the hyperdimensional image vector representations and the hyperdimensional text vector representations;
embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars;
project the at least one hyperdimensional query vector representations into the common hyperdimensional embedding space;
determine a similarity measure between the projected at least one hyperdimensional query vector representations and at least one of the respective exemplars; and
identify an exemplar having a highest degree of similarity measure to the projected at least one hyperdimensional query vector representations in the hyperdimensional embedding space; and
using information associated with the identified exemplar, mark the subject image to indicate at least one of an object or a visual grounding of the object in the subject image in response to the query request.

13. The apparatus of claim 12, wherein the mark comprises a bounding box.

14. The apparatus of claim 12, wherein the apparatus is further configured to at least one of:
convert descriptions of the image received at the edge device to text; or
convert the query request to text.

15. The apparatus of claim 12, wherein the apparatus is further configured to:
use the at least one hyperdimensional query vector representations to search a high-dimensional vector database for data related to the query search; and
use related data of the high-dimensional vector database identified as a result of the search to at least one of create additional exemplars or assist to identify the exemplar having a highest degree of similarity measure to the projected at least one hyperdimensional query vector representations in the hyperdimensional embedding space.

16. The apparatus of claim 15, wherein information representative of the related data of the high-dimensional vector database identified as a result of the search is projected into the common hyperdimensional embedding space to assist to identify the exemplar having a highest degree of similarity measure.

17. The apparatus of claim 12, wherein the apparatus is further configured to:
determine a similarity measure threshold for determining which exemplars in the hyperdimensional embedding space to identify in response to the received query request.

18. A system for object detection and visual grounding, comprising:
an edge device comprising a processor and a memory accessible to the processor, the memory having stored therein at least one of programs or instructions executable by the processor to configure the edge device to:
project a hyperdimensional vector representation of at least one of an image of a received query request or a text of the received query request into a hyperdimensional embedding space to identify at least one of an object or a visual grounding of an object in a subject image using a network of the edge device trained to:
determine at least one region of interest for at least one of an image received at the edge device and at least one respective description of the image received at the edge device;
generate, for each region of interest determined, a numerical image vector representation of a respective portion of the image and a numerical text vector representation of text of a respective portion of the descriptions of the image;
generate a numerical query vector representation of at least one of an image or a text of the query request;
generate a respective hyperdimensional image vector representation and a respective hyperdimensional text vector representation for each of the numerical image vector representations and the numerical text vector representations;
generate a hyperdimensional query vector representation of the at least one numerical query vector representation;
combine respective ones of the hyperdimensional image vector representations and the hyperdimensional text vector representations;
embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars;
project the at least one hyperdimensional query vector representations into the common hyperdimensional embedding space;
determine a similarity measure between the projected at least one hyperdimensional query vector representations and at least one of the respective exemplars; and
identify an exemplar having a highest degree of similarity measure to the projected at least one hyperdimensional query vector representations in the hyperdimensional embedding space; and
using information associated with the identified exemplar, mark the subject image to indicate at least one of an object or a visual grounding of the object in the subject image in response to the query request.

19. The system of claim 18, wherein the edge device further comprises a high-dimensional vector database and wherein the edge device is further configured to:
use the at least one hyperdimensional query vector representations to search the high-dimensional vector database for data related to the query search; and
use related data of the high-dimensional vector database identified as a result of the search to at least one of create additional exemplars or assist to identify the exemplar having a highest degree of similarity measure to the projected at least one hyperdimensional query vector representations in the hyperdimensional embedding space.

20. A non-transitory computer readable medium having stored thereon at least one program, the at least one program including instructions which, when executed by a processor, cause the processor to perform a method for object detection and visual grounding on an edge device, comprising:
projecting a hyperdimensional vector representation of at least one of an image of a received query request or a text of the received query request into a hyperdimensional embedding space to identify at least one of an object or a visual grounding of an object in a subject image using a network of the edge device trained to:
determine at least one region of interest for at least one of an image received at the edge device and at least one respective description of the image received at the edge device;
generate, for each region of interest determined, a numerical image vector representation of a respective portion of the image and a numerical text vector representation of text of a respective portion of the descriptions of the image;
generate a numerical query vector representation of at least one of an image or a text of the query request;
generate a respective hyperdimensional image vector representation and a respective hyperdimensional text vector representation for each of the numerical image vector representations and the numerical text vector representations;
generate a hyperdimensional query vector representation of the at least one numerical query vector representation;
combine respective ones of the hyperdimensional image vector representations and the hyperdimensional text vector representations;
embed the respectively combined hyperdimensional image vector representations and hyperdimensional text vector representations into a common hyperdimensional embedding space, which preserves a high cosine similarity of the respectively combined hyperdimensional image vector representations and hyperdimensional text vector representations, to generate respective exemplars;
project the at least one hyperdimensional query vector representations into the common hyperdimensional embedding space;
determine a similarity measure between the projected at least one hyperdimensional query vector representations and at least one of the respective exemplars; and
identify an exemplar having a highest degree of similarity measure to the projected at least one hyperdimensional query vector representations in the hyperdimensional embedding space; and
using information associated with the identified exemplar, mark the subject image to indicate at least one of an object or a visual grounding of the object in the subject image in response to the query request.
